(19) United States
(12) Patent Application Publication
(10) Pub. No.: US 2004/0202099 A1
(43) Pub. Date: Oct. 14, 2004

(54) Damper with different damping power in different axes

(76) Inventors: Gary Huang, Taoyuan (TW); Eric Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/065,652

(22) Filed: Nov. 6, 2002

(51) Int. Cl. G11B 17/00; G11B 21/16; G11B 23/00; G11B 25/00

(52) U.S. Cl. 369/292

(57) ABSTRACT

A damper suitable for buffering minor vibration is provided. By changing the shape of the damper in its radial direction or forming a plurality of caves in the damper, the coefficient of elasticity of damper in its axial directions can be changed. Relatively, the damping power of the damper in its different axes can be adjusted. Furthermore a damper structure comprises a damper and a clamp which allows a change in the amount and the placement of the contact surface area between the damper and the clamp to adjust the damping power of the damper structure in different axes.

### BACKGROUND OF INVENTION

1. Field of the Invention

The present invention generally relates to a damper, and particularly to a damper that can provide different damping power in different axes.

2. Description of Related Art

The fast development in computer technology has continuously created many new computer peripherals. Use optical disc drive (hereinafter ODD) as an example, it is mainly divided into “read only”, “write only”, and “re-writable”. For a re-writable ODD, the maximum speed of data reading and writing is constantly reaching new grounds, and therefore the drive itself must be correspondingly improved to handle the increased operation speed for matching the increased data reading and writing speed of the head. However, problems deriving from disc bias or the drive itself cause the ODD to vibrate vigorously under high speed spinning of the disc which prevents the ODD from accurately performing read/write data operation. As a result, prior art installs a plurality of dampers in the drive to reduce the amount of minor vibration under high-speed operation of the drive which allows data reading and writing to perform normally.

Please refer to FIG. 1, it shows an exploded view of the components of a conventional ODD. As shown in FIG. 1, a ODD 10 comprises a loader 12, a traverse 14, a motor 14a (the source of vibration), a dynamic mass 16, a body (not shown), and the like. Furthermore for providing the ODD with plenty of damping, prior art provides a plurality of isolators 20a, a plurality of dampers 20b inside the drive, and a plurality of clamps 18a and 18b for clamping the isolators 20a and the dampers 20b. It is to be noted that the shape of the isolators 20a and dampers 20b are very similar but their dimensions are different, therefore a simple explanation of the isolators 20a and corresponding clamps 18a is given below.

Please refer to FIG. 2A, it shows a schematic diagram of an isolator 20a and the corresponding clamp 18a in the conventional ODD. The conventional isolator 20a comprises a radial trench 22 and a longitudinal through-hole 24. Wherein the radial trench 22 is parallel to the radius of the isolator 20a (i.e. the left and right direction in the diagram) and caved into the lateral surface area of the isolator 20a, and the longitudinal through-hole 24 is parallel to the longitude of the isolator 20a (i.e. the up and down direction in the diagram) and penetrates through the body of the isolator 20a. The clamp 18a clamps to isolator 20a by the radial trench 22.

Please simultaneously refer to FIGS. 1 and 2B, wherein FIG. 2B shows a schematic partial diagram of the isolator 20a installed in the ODD 10. The isolators 20a are secured on the clamps 18a and are disposed between the support members 26a and 26b. Wherein the clamp 18a is part of the drive structure 14 and the supporting member 26a is part of the body (not shown), and the supporting member 26b is part of the loader 12. Therefore the when the longitudinal end outer surfaces of the isolator 20a touch the supporting members 26a and 26b, the clamp 18a are engaged to clamp the isolators 20a by the radial trenches 22. Furthermore a longitudinal fastener (such as a screw) penetrates through the supporting member 26a, the longitudinal through-hole 24, and the supporting member 26b and couples to the supporting members 26a and 26b. The corresponding space between the supporting members 26a and 26b is fixed when the body and the loader 12 are coupled together.

Please simultaneously refer to FIGS. 1 and 2B, the material of the isolators 20a is an elastic material so to allow the isolators 20a to absorb and buffer vibration. Therefore minor vibrations generated from the motor 14a of the drive structure 14 will be transferred to the isolators 20a via the clamps 18a. The isolators 20a will absorb and buffer the vibrations to prevent the vibrations affecting the loader 12 and the body, and at the same time the loader 12 will not be affected by external minor vibrations because they are redirected to the isolators 20a from the supporting members 26a and 26b. Similarly, the vibrations are absorbed and buffered by the isolators 20a so most of the vibrations will not be transferred to the drive structure 14 via the clamp 18a which affects normal data reading and writing operation. As a result, as illustrated in FIG. 1, prior uses a plurality of isolators 20a and dampers 20b together with a plurality of clamps 18a and 18b to suspend the loader 12 of a ODD 10 inside the ODD 10.

Nonetheless, the conventional ODD uses dampers (i.e. the isolators and dampers described in the aforementioned) with identical shapes (of a circular column or dumbbells) located inside the ODD for absorbing and buffering the minor vibrations generated by the motor or from an external source. It is to be noted that the vibration occurring at different points and furthermore different axes of the ODD contribute to different levels of effects to the operation of the ODD. Therefore due to the shape of all the dampers used for absorbing and buffering vibrations being identical, prior cannot comprehensively provide the best damping for the ODD by accurately locating the source of the vibration in the correct axis.

### SUMMARY OF INVENTION

The present invention provides a damper that can adjust the coefficient of elasticity in different axes to adjust the damping effect in different axes byspecifically catering to the source of vibration in different axes.

According to the aforementioned objects, the present invention provides a damper with a radial trench that caves into the lateral surface area of the damper and is parallel to the radius of the damper. The traversal cross-section of the radial trench along the radius is not 90-degrees-cyclic-quadrant-symmetric with non-equal distances from the center to the contact surface of the radial trench at different sides. The shape can be a rectangle, oval, or a shape generated by a high-power polynomial curve. The damper also has a longitudinal through-hole which is parallel to the longitude of the damper and penetrates through the damper.

Similarly according to the aforementioned objects, the present invention provides a damper with a radial trench that caves into the lateral surface area of the damper and is parallel to the radius of the damper. Furthermore the damper has a plurality of longitudinal slots caved into either the outer or inner traversal planar surfaces of the damper. These longitudinal slots are parallel to the longitude of the damper. The damper also has a longitudinal through-hole which is parallel to the height of the damper and penetrates through the damper.

Similarly according to the aforementioned objects, the present invention provides a damper structure comprising a damper and a clamp. The damper has a radial trench that caves into the lateral surface area of the damper and is parallel to the radius of the damper. The clamp clamps onto the damper by the inner planar surfaces of the radial trench, wherein the contact surface area of the clamp is less than the total surface area of the radial trench. The damper also has a longitudinal through-hole which is parallel to the height of the damper and penetrates through the damper.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an exploded view of the components of a conventional ODD.

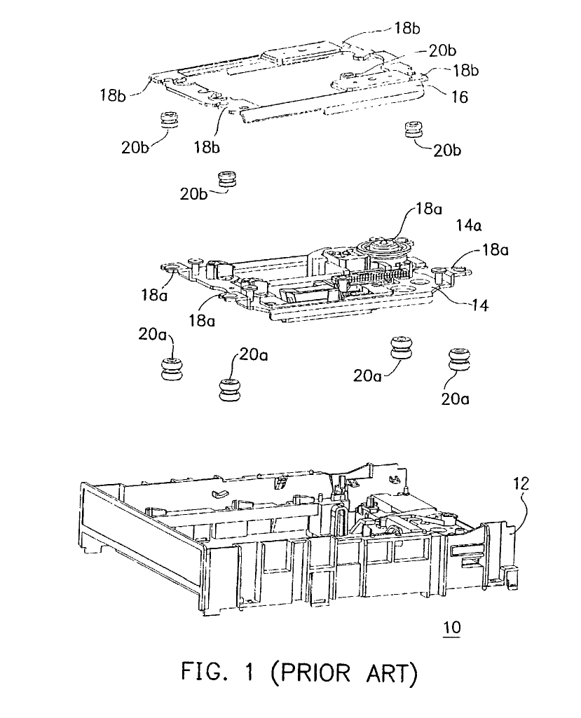

FIG. 2A is a schematic diagram of an isolator and the corresponding clamp in the conventional ODD.

FIG. 2B is a schematic partial diagram of the isolator installed in the ODD in FIG. 1.

FIG. 3A to 3D are schematic diagrams of four different dampers according to the first embodiment of the present invention.

FIG. 4A to 4B are schematic diagrams of two different dampers according to the second embodiment of the present invention.

FIG. 5 is a schematic diagram of a damper structure according to a third embodiment of the present invention.

### DETAILED DESCRIPTION

First Embodiment

For the purpose of having different damping power in different axes of the damper, the first embodiment provides a damper with traversal cross-sectional planar surfaces of different shapes that is not 90-degrees-cyclic-quadrant-symmetric. That is the distance between the center of the shape to the parallel line of the points located the same axis will be different if the shape is rotated 90 degrees. These shapes can be a rectangle, oval, or formed by a high-power polynomial curve, and the like. As a result, the damper has different coefficient of elasticity in different axes to adjust the damping effect in different axes by changing the orientation of the damper.

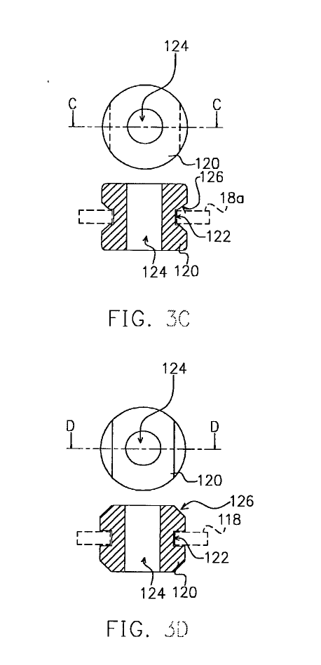

Please refer to FIG. 3A, it shows a schematic diagram of a damper according to the first embodiment of the present invention. The damper 120 has a radial trench 122 which is parallel to the radius of the damper 120 (i.e. the left and right direction in the diagram) and caves into the lateral surface area of the damper 120. The clamp 118 clamps onto the damper 120 by the radial trench 122. The traversal cross-sectional planar surface of the radial trench 122 is not 90-degrees-cyclic-quadrant-symmetric, which is a rectangular in this particular embodiment, but the shape can be any other non-circular and non-square shape (i.e. not 90-degrees-cyclic-quadrant-symmetric) as mentioned above. Furthermore the shape of the clamp 118 must match the shape of the radial trench 122 so that the clamp 118 can clamp onto the damper 120 by the radial trench 122. By having this unique non-90-degrees-cyclic-quadrant-symmetric shape characteristics, the damping effect in different axes are adjusted accurately according to the source of vibration.

Please refer to FIG. 3B, it shows a second damper according to the first embodiment of the present invention. A damper 120 has a radial trench 122 which is parallel to the radius of the damper 120 (i.e. the left and right direction in the diagram) and caves into the lateral surface area of the damper 120. The clamp 118 clamps onto the damper 120 by the radial trench 122. The traversal cross-sectional outer planar surface of the damper 120 is not 90-degrees-cyclic-quadrant-symmetric, which is a rectangular in this particular embodiment, but the shape can any other non-circular shape and non-square as mentioned above. By having this unique non-90-degrees-cyclic-quadrant-symmetric shape characteristics, the damping effect in the different axes are adjusted accurately according to the source of vibration.

Please refer to FIG. 3C, it shows a third damper according to the first embodiment of the present invention. A damper 120 has a radial trench 122 which is parallel to the radius of the damper 120 (i.e. the left and right direction in the diagram) and caves' into the lateral surface area of the damper 120. The clamp 118 clamps onto the damper 120 by the radial trench 122. Furthermore two opposite outer edges of both the bottom and the top inner planar surfaces of the radial trench 122 are cut to have chamfers 126. The shape of the traversal cross-section of the radial trench 122 shows a shape with two straight edges connected by two arcs, but the shape can be any other non-circular shape and non-square (i.e. not 90-degrees-cyclic-quadrant-symmetric) as mentioned above. As a result the cut-view along CC shows the side-view of the radial trench being a trapezoidal shape due to the chamfers. By having this unique shape characteristics, the damping effect in the different axes are adjusted differently.

Please refer to FIG. 3D, it shows a fourth damper according to the first embodiment of the present invention. A damper 120 has a radial trench 122 which is parallel to the radius of the damper 120 (i.e. the left and right direction in the diagram) and caves into the lateral surface area of the damper 120. The clamp 118 clamps onto the damper 120 by the radial trench 122. Furthermore two opposite outer edges of both the bottom and the top outer planar surfaces of the damper 120 are cut to have chamfers 126. The shape of the traversal cross-section top view of the damper 120 shows a shape with two straight edges connected by two arcs, but the shape can be any other non-circular shape and non-square (i.e. not 90-degrees-cyclic-quadrant-symmetric) as mentioned above. As a result the cut-view along DD shows the side-view of the damper with chamfered bottom and top outer round edge. By having this unique non-90-degrees-cyclic-quadrant-symmetric shape characteristics, the damping effect in the different axes are adjusted accurately according to the source of vibration.

According to the above, the present invention provides a damper that has a traversal cross-section planar surface which is not 90-degrees-cyclic-quadrant-symmetric and is a non-circular or non-square shape such that the coefficient of elasticity of the damper is changed to adjust the damping effect in different axes of the damper.

Second Embodiment

The second embodiment of the present invention provides a damper having internal longitudinal slots for changing the coefficient of elasticity in different axes to adjust the damping effect of the damper in different axes.

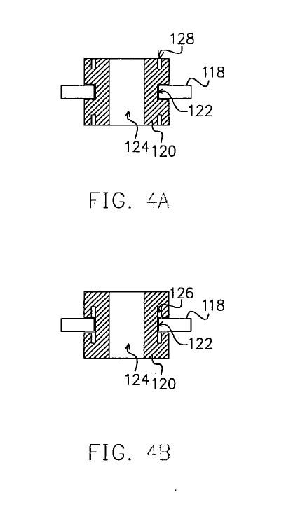

Please refer to FIG. 4A, it shows a first damper according to the second embodiment of the present invention. A damper 120 has a radial trench 122 which is parallel to the radius of the damper 120 (i.e. the left and right direction in the diagram) and caves into the lateral surface area of the damper 120. The clamp 118 clamps onto the damper 120 by the radial trench 122. Furthermore it is to be noted that the damper 120 has a plurality of longitudinal slots 128 caved into the bottom and top planar surfaces of the damper 120. The longitudinal slots 128 are parallel to the longitudinal axis and are in the form of a blind hole or an arc. The longitudinal slots 128 are blind longitudinal slots that do not penetrate through the damper 120 or the radial trench.

Please refer to FIG. 4B, it shows a second damper 120 according to the second embodiment of the present invention. A damper 120 has a radial trench 122 which is parallel to the radius of the damper 120 (i.e. the left and right direction in the diagram) and caves into the lateral surface area of the damper 120. The clamp 118 clamps onto the damper 120 by the radial trench 122. Furthermore it is to be noted that the damper 120 has at least one longitudinal slot 128 caved into the bottom and top inner planar surfaces of the radial trench 122. The longitudinal slots 128 are parallel to the longitude and are in the form of a blind hole or an arc which are connected and intersected to the radial trench 122. The longitudinal slots and the radial trench form a sideways T-shape on two opposite ends when seen in a longitudinal cut-view along the diameter of the damper 120. The longitudinal slots 128 are blind longitudinal slots that do not penetrate the damper 120.

According to the above, the damper of the second embodiment has longitudinal slots that are caved into the top and bottom planar surfaces of the damper for changing the coefficient of elasticity in different axes for adjusting the damping effect of the damper in different axes.

Third Embodiment

The third embodiment of the present invention provides a damper structure comprising a damper and a clamp which changes the amount of contact surface area to adjust the damping effect of the damper in different axes.

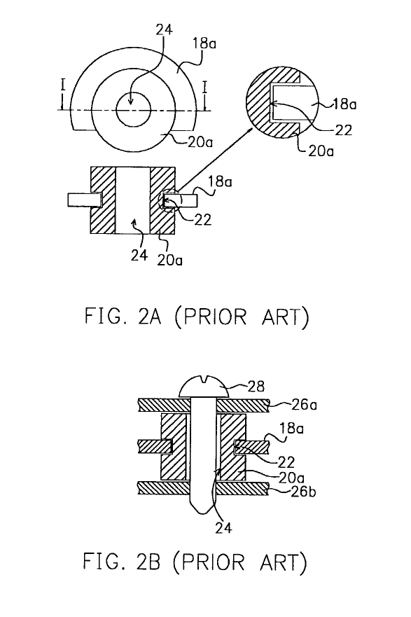

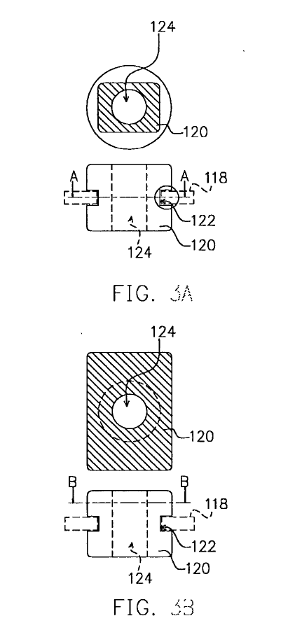

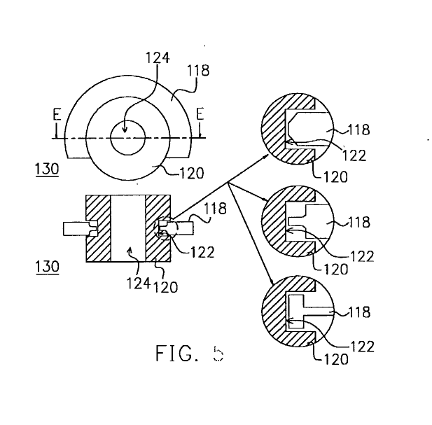

Please refer to FIG. 5, it shows a schematic diagram of a damper structure of the present invention. A damper structure 130 comprises a damper 120 and a clamp 118. The damper 120 has a radial trench 122 which is parallel to the radius of the damper 120 (i.e. the left and right direction in the diagram) and caves into the lateral surface area of the damper 120. The clamp 118 clamps onto the damper 120 by the radial trench 122. It is to be noted that the clamp 118 is different from the clamp 18a in FIG. 2 by having chamfered or removed edges at the end where the clamp 118 clamps onto the damper 120. As a result the contact surface area between the clamp 18 and the radial trench 122 is smaller which allows the configuration of the contact surface areas according to the source of vibration.

According the above, the third embodiment of the present invention provides a damper structure that changes the contact surface area between the clamp and the damper to adjust the damping effect of the damper in different axes.

Summarizing the above, the present invention provides a damper by changing the shape of the traversal cross-section view along a plane parallel to the radius or adding a plurality of longitudinal slots caved into the top and bottom outer planar surfaces of the damper to change the coefficient of elasticity of the damper in different axes. The shape of the traversal cross-section is not 90-degrees-cyclic-quadrant-symmetric, i.e. it is not a circle or a square. As a result, the damping effect of the damper in different axes can be adjusted. Furthermore, the present invention provides a damper structure comprising a damper and a clamp for adjusting the damping effect of the damper in different axes by changing the contact surface area between the damper and the clamp. Therefore at different installation points within the same ODD, different damper and damper structures in different orientation with different damping power in different axes can be employed for optimal damping. Consequently the performance on data read/write operation is increased. Finally, the dampers of the present invention do not solely apply to ODDs but can be applied to any other devices and components which requires buffering of minor vibrations for optimal damping.

It will be apparent to those skilled in the art that various modifications and variations can be made to the structure and method of the present invention without departing from the scope or spirit of the present invention. In view of the foregoing description, it is intended that the present invention covers modifications and variations of this invention provided they fall within the scope of the following claims and their equivalents.

1. A damper comprising a radial trench, wherein the radial trench is caved into a lateral surface area of the damper and a shape of a traversal cross-section parallel to a radius of a damper is not 90-degrees-cyclic-quadrant-symmetric.

2. The damper in claim 1, wherein the shape of the traversal cross-section parallel to the radius of the damper comprises at least two different curves.

3. The damper in claim 1 further comprises a longitudinal through-hole that penetrates through the damper is parallel to a longitude of the damper.

4. A damper comprising a radial trench and a slot, wherein the radial trench is caved into a lateral surface area of the damper and the slot is caved into outer surfaces of the damper.

5. The damper in claim 4, wherein the slot is a longitudinal slot which caves into the outer surfaces of the damper and are parallel to a longitude of the damper.

6. The damper in claim 5, wherein the radial trench intersects with the slot.

7. The damper in claim 4 further comprising a longitudinal though-hole that penetrates through the damper and is parallel to a longitude of the damper.

8 A damper structure comprising:
a damper comprising a radial trench which caves into a lateral surface area of the damper and is parallel to a radius of the damper;
a clamp which engages to clamp onto the damper by the radial trench, wherein
a surface contact area between the clamp and the damper is smaller than an inner surface area of the radial trench.

9. The damper in claim 9, wherein the damper further comprising a longitudinal through-hole which penetrates through the damper and is parallel to a longitude of the damper.
